(19) United States
(12) Patent Application Publication
(10) Pub. No.: US 2001/0046414 A1
(43) Pub. Date: Nov. 29, 2001

(54) Apparatus and method for in situ remediation

(76) Inventor: Lawrence John Kinsman, Madison, WI (US)

Correspondence Address: Bennett J. Berson, Quarles & Brady LLP, 1 South Pinckney Street, P O Box 2113, Madison, WI, 53701-2113, US

(21) Appl. No.: 09/789,910

(22) Filed: Feb. 21, 2001

Related U.S. Application Data
(60) Provisional application No. 60/183,947, filed on Feb. 22, 2000.

(51) Int. Cl. B09C 1/02

(52) U.S. Cl. 405/128.75; 166/54.1; 166/227

(57) ABSTRACT

In the present invention, a plurality of conduits are employed for introducing Fenton's reagent reaction components separately into a site for treating a target contaminant. The conduits are disposed in a subsurface borehole which can be positioned, prepared and sealed as in the prior art. At the surface-accessible end of each conduit, an injection head is provided. At the subsurface end of each conduit, various means are provided for allowing the components to contact one another to form Fenton's reagent and for delivering the reagent to the contamination site.

### CROSS-REFERENCE TO RELATED APPLICATIONS

This application claims the benefit of U.S. provisional application 60/183,947, filed on Feb. 22, 2000, which is incorporated herein in its entirety.

### STATEMENT REGARDING FEDERALLY SPONSORED RESEARCH OR DEVELOPMENT

Not applicable.

### BACKGROUND OF THE INVENTION

Representative examples of devices and methods for remediating, e.g., DNAPLs and LNAPLs in soil and groundwater that use Fenton's reagent include U.S. Pat. Nos. 5,520,483; 5,525,008; 5,611,642; 5,741,427; and 5,286,141, each incorporated herein by reference as if set forth in its entirety. The incorporated patents disclose principles of treating subsurface contamination, including how and where to place boreholes to ensure treatment of subsurface contamination. Such principles are considered to be well within the level of ordinary skill in the art and are not further detailed herein.

In all known in situ remediation methods that utilize Fenton's reagent, the reaction components (namely, hydrogen peroxide and iron sulfate catalyst) are either (1) added sequentially so that mixing occurs in the site or (2) are mixed prior to being introduced into the subsurface (subterranean) remediation site. Each of these methods has significant shortcomings. The former method depends on the normal diffusive characteristics of the remediation site to mix separately introduced reaction components in the soil and groundwater and thus is inefficient, time consuming and expensive. This method can also be hazardous as an explosively high concentration of hydrogen peroxide can accumulate near the well if the reaction components are inefficiently dispersed. The latter method is also inefficient in that the components disadvantageously react with each other before having an opportunity to productively react with the contaminant in the lithology. Moreover, when the components are mixed together in the latter method, they become violently reactive and can explode while being delivered to the remediation site.

Thus an apparatus and methods for in situ remediation using Fenton's reagent that overcome the known disadvantages of existing remediation systems are desired.

### BRIEF SUMMARY OF THE INVENTION

The present invention is summarized in that a method for subsurface in situ remediation (or decrease in concentration of a contaminant) using Fenton's reagent includes the steps of separately delivering each component of Fenton's reagent in a conduit to a site to be remediated, wherein the components do not mix with one another until both components reach the remediation site.

The present invention is further summarized in that an apparatus suited for practice of the method comprises at least one pair of conduits for introducing and mixing Fenton's reagent reaction components in a subsurface borehole which can be provided and positioned near a target contaminant as in the prior art. Each conduit has a subsurface end and a surface-accessible end provided outside of a seal that isolates the apparatus from the surface environment. An injection head is provided at the surface-accessible end of each conduit. At the subsurface end of each conduit, means are provided for combining the reaction components that are separately introduced into the borehole. In a first embodiment, the conduits fluidly communicate directly with an outlet in which the reaction components mix and through which the mixed reaction components enter the remediation site. In a related embodiment, both subsurface conduit ends comprise an outlet and the pair of outlets are provided in a larger outlet that is less permeable and has a slower outflow rate than the outlets attached to the conduits, such that adequate mixing of reaction components can occur inside the larger outlet before the mixed components are delivered to the remediation site. In yet another embodiment, the channels can fluidly communicate with a coupling wherein the components are mixed before exiting the apparatus via the outlet. In still another embodiment, a first conduit for delivering a first reaction component resides inside a second conduit used for delivering a second reaction component. In all embodiments, the reaction components delivered by the two conduits do not mix before reaching the subsurface ends of the conduits, which are in fluid communication with a mixing coupling and outlet, or directly with an outlet.

It is an object of the present invention to mix the reaction components just before being introduced to a remediation site.

It is an advantage of the present invention that efficiency benefits are realized in the Fenton's reaction because the components mix just before being introduced into a remediation site, as opposed to the devices and methods of the prior art wherein undesired and sometimes violent reaction can occur in the injection head and/or in the conduit when the components are introduced sequentially.

It is another advantage of the present invention that the injection heads can be moved from one location to another quickly and safely since the reactive components do not mix and do not react at the injection head end of the conduits.

Further objects, features and advantages of the invention will be apparent from the following detailed description when taken in conjunction with the accompanying claims and drawings.

### BRIEF DESCRIPTION OF THE SEVERAL VIEWS OF THE DRAWINGS

FIG. 1 depicts an embodiment of the two conduit injection system of the present invention.

FIG. 2 depicts an alternate embodiment of the two conduit system.

FIG. 3 details the assembly of the embodiment of FIG. 2.

FIG. 4 depicts another alternate embodiment of the two conduit system.

FIG. 5 depicts use of multiple two conduit systems for remediating a site at various depths.

### DETAILED DESCRIPTION OF THE INVENTION

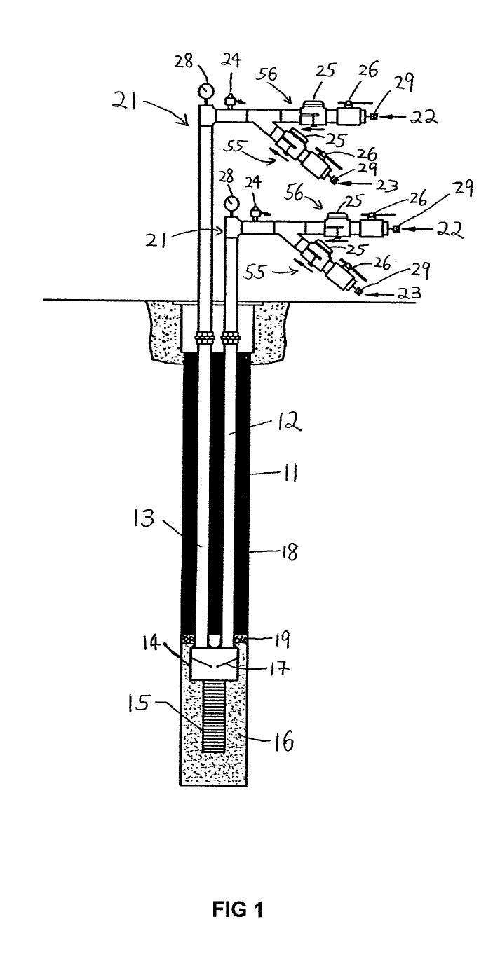

One embodiment of the present invention is shown in FIG. 1. A plurality, at least a pair, of separate non-corrosive pipes 12, 13 of similar diameter, each having a surface-accessible (upper) end and a subsurface (lower) end are provided in a conventional borehole 11 at a suitable depth. Procedures for making boreholes are well known to one of ordinary skill in the art. For example, a hollow-bore auger can be used to dig the hole and the pipe assembly can be placed in the hole through the hollow space in the middle of the auger. The borehole that accommodates the apparatus can be made and filled in accord with convention in the art.

The surface-accessible end of each pipe is coupled to an injection head 21 through which a reaction component can be provided. The subsurface end of each pipe is coupled with a substantially fluid-tight seal to a non-corrosive mixing coupling 14 having an upper surface that defines openings for fluid communication with the pipes 12, 13. The mixing coupling 14 of FIG. 1 can define a chamber of in any shape and can have no internal structure (a “static mixer”) for promoting mixing of the reagents. It can, on the other hand, contain fluid-disturbing structures for encouraging mixing of the reaction components. Examples of such structures include blades or flaps 17 (as shown in FIG. 1) extended from the interior walls and a funnel arrangement in the mixing coupling's interior beneath the pipes.

The mixing coupling 14 also has a lower surface that defines at least one opening for substantially fluid-tight connection to an outlet in fluid communication with the coupling 14 for receiving mixed reactants. The outlet is permeable such that the mixed components in the outlet exit the apparatus into the lithology while preventing foreign matter from entering the apparatus. In the embodiment of FIG. 1, the outlet is a conventional well screen 15 that can be made of stainless steel or other material that is sufficiently non-corrosive to endure the subsurface environment in which the apparatus finds application. For example, the well screen can be a hollow plastic cylinder made of PVC having holes of appropriate size therethrough on the cylinder walls. The screen can also be a stainless steel coil with appropriate spaces in between.

A skilled artisan understands the attributes of the injection heads coupled to each pipe 12, 13 at the surface-accessible end. On the injection heads 21, valves such as a pressure relieve valve 24, check valves 25 and ball valves 26, gauges such as a pressure gauge 28, and couplings such as quick-connect couplings 29 of a type known in the art facilitate operation. In a preferred embodiment, each injector head comprises a pair of inputs 55 and 56 for feeding the reaction components into the pipes as shown in FIG. 1 where one of inputs 55 and 56 is coupled to a reaction component (shown schematically at 22) and the second input is coupled to a source of compressed air (shown schematically at 23) for urging the reaction component 22 into the pipe. While the injection head inputs 55 and 56 are provided on a single side of the pipe in FIG. 1, they can also be located on opposite sides in a T- or substantially T-shaped structure. Releasable coupling means, such as threaded ends, can be provided at the surface-accessible end of the on the pipes 12, 13, if removable injection heads are contemplated.

The apparatus can be sealed in the borehole as in conventional one pipe systems. The mixing coupling 14 and the well screen 15 can be surrounded and stabilized by particulate material 16, such as sand, preferably silica sand having a particle size sufficiently large that it is substantially prevented from entering the well screen 15. The pipes can be stabilized in the borehole with grout 18 with an optional layer of bentonite 19 or other clay material therebetween. When a hollow bore auger is used, sand 16, bentonite 19 and grout 18 can be place in the borehole while the auger is being retrieved after the pipe assembly has been placed in the borehole.

In use, an iron sulfate reaction catalyst is added via a first injection head to a first conduit and hydrogen peroxide is added via a second injection head to a second conduit. The Fenton's reagent reaction components do not mix during delivery in the conduits to the treatment site, but rather mix after the components have left the conduits, optionally in the mixing coupling, before exiting from the apparatus outlet into the treatment site.

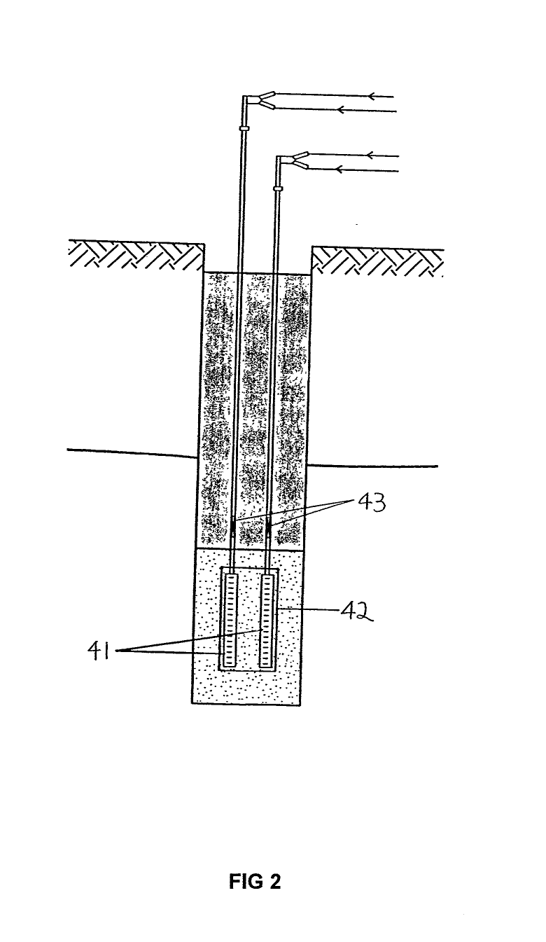

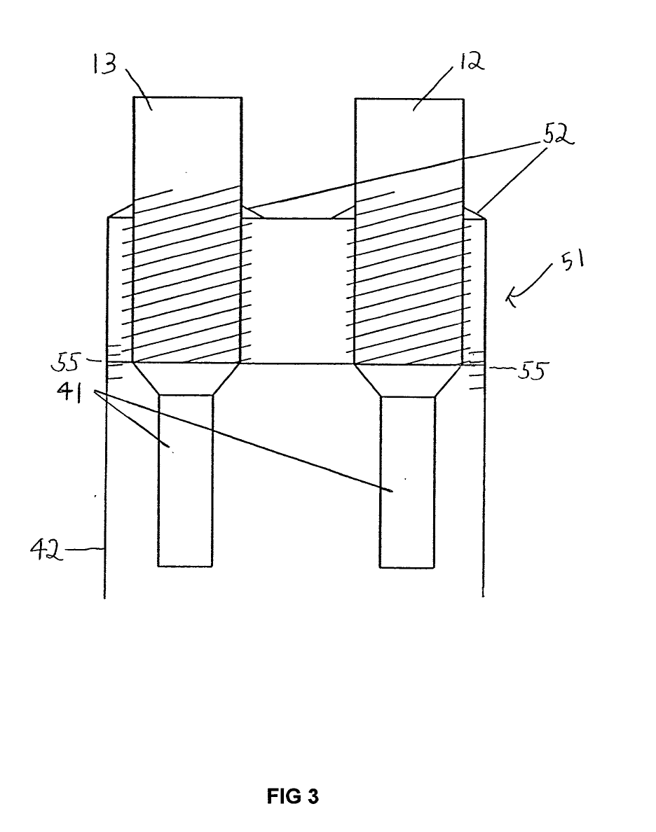

FIG. 2 depicts an related embodiment wherein no mixing coupling is provided and the lower end of each pipe 12, 13 is connected to its own well screen 41. The well screens, in turn, are disposed inside a larger well screen 42 that is less permeable and has a slower outflow rate than those attached to the pipes, such that adequate mixing of reaction components can occur inside the larger well screen before the mixed components are delivered to the remediation site. FIG. 3 shows how the pipes 12, 13, the small screens 41 and the large screen 42 are assembled together using connector 51. Connector 51 defines at least a pair of female threaded 52 channels therethrough and is further provided with a male thread on an outer surface. Each female threaded channel receives from one side of the connector 51 a pipe 12 or 13 and from the other side of the connector 51 a well screen 41. Larger well screen 42 is threaded to the connector 51 at 55. In this embodiment, a back flow preventer 43 can be used with each pipe near the lower end of the pipe.

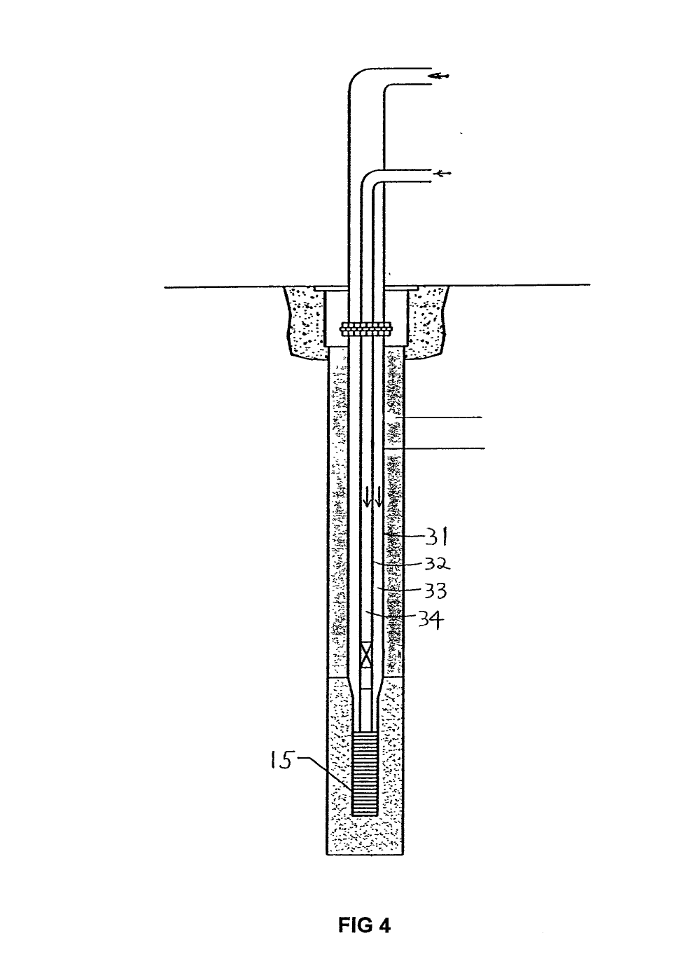

In another arrangement, as shown in FIG. 4, the pipes are not separate and do not have similar or identical diameters. This arrangement employs a pipe 31 having an inside wall and an inner diameter sufficiently large to accommodate a smaller inner pipe 32. Inner pipe 32 has an outer wall and an outer diameter smaller than the inner diameter of pipe 31. Channel 33 is defined by the inside wall of pipe 31 and the outside wall of pipe 32. Channel 34 is defined by the inside wall of inner pipe 32. A mixing coupling can also be provided to connect the pipes and the screen in this embodiment. The components are delivered separately to the subsurface via the channels 33, 34 and do not mix until they reach screen 15, which is connected to pipe 31, as shown in FIG. 4.

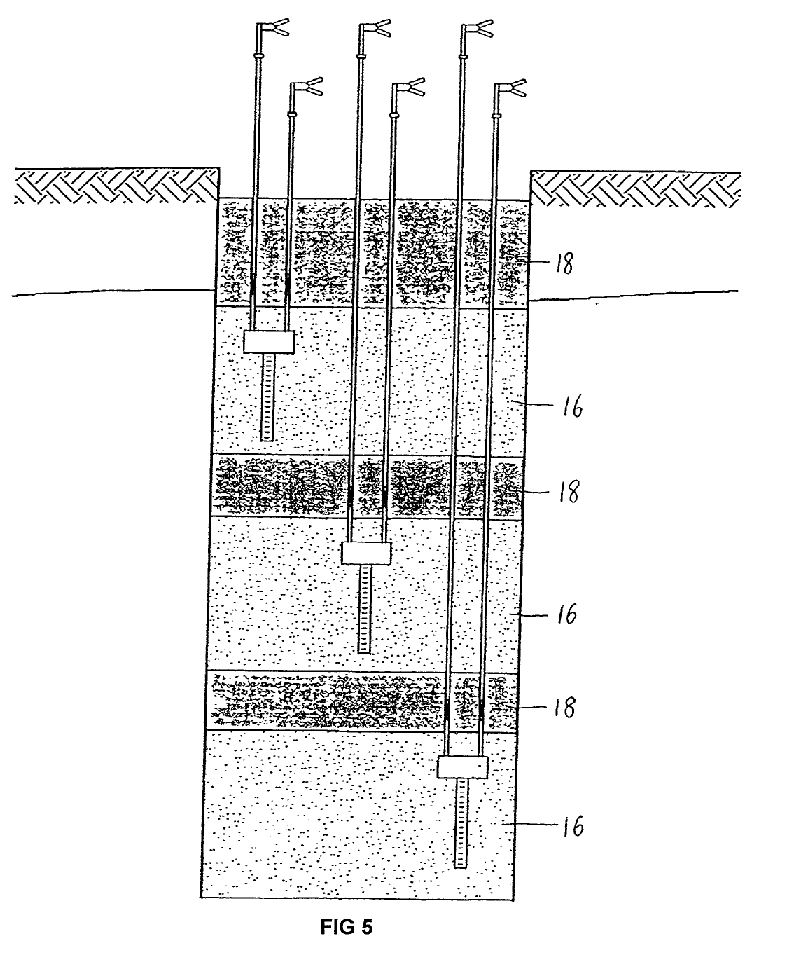

Depending on whether the contaminants to be remediated are, e.g., DNAPLs (dense non-aqueous phase liquids) or LNAPLs (light non-aqueous phase liquids), the contamination may be found at different depths from the ground surface. LNAPLs such as gasoline are typically found closer to the surface than DNAPLs such as chlorinated solvents TCE and PCE. It will be understood that multiple two-pipe systems of the types disclosed can be positioned at distinct depths by varying the pipe lengths to remediate contaminants located at various distances below the surface (shown in FIG. 5).

The apparatus has been successfully used for in situ subsurface remediation to decrease the amount and concentration of both subsurface DNAPLs and LNAPLs using Fenton's reagent prepared in accordance with the method of the invention.

It is understood that the particular embodiments set forth herein are illustrative and not intended to confine the invention, but embraces all such modified forms thereof as come within the scope of the following claims.

I claim:

1. An apparatus for in situ subsurface remediation of a chemical contaminant, the apparatus comprising:
at least a pair of conduits for separate introduction of a reaction component to a remediation site, each conduit having a surface-accessible end and a subsurface end; and
an injection head in fluid communication with the surface-accessible end of each conduit.

2. The apparatus of claim 1 wherein the conduits are separate conduits.

3. The apparatus of claim 1 wherein a first conduit is provided inside a second conduit.

4. The apparatus of claim 1 wherein each conduit further comprises a well screen in fluid communication with the subsurface end.

5. The apparatus of claim 1 further comprising an outlet in fluid communication with the subsurface ends of the conduits.

6. The apparatus of claim 5 wherein the outlet comprises a well screen.

7. The apparatus of claim 5 further comprising a well screen at the subsurface end of each conduit, each well screen being in fluid communication with one conduit and with the outlet.

8. The apparatus of claim 7 wherein the outlet comprises a well screen and all well screens at the subsurface ends of the conduits are provided inside of the outlet well screen.

9. The apparatus of claim 5 further comprising a mixing coupling in fluid communication with the conduits and with the outlet.

10. The apparatus of claim 8 further comprising a fluid-disturbing structure in the mixing coupling.

11. The apparatus of claim 1 wherein each injection head comprises two inputs.

12. An in situ method for decreasing concentration of one or more chemical contaminants at a subsurface treatment site using Fenton's reagent, the reagent comprising an iron sulfate reaction catalyst component and a hydrogen peroxide component, the method comprising:
separately introducing the catalyst component and the peroxide component into surface-accessible ends of a separate conduit to the treatment site without mixing the components until each component leaves a subsurface end of said conduit;
mixing the components in situ to produce Fenton's reagent; and
allowing the Fenton's reagent to interact with the one or more chemical contaminant at the treatment site until the contaminant concentration decreases.

13. An in situ method as claimed in claim 12 wherein at least two chemical contaminants are treated at different subsurface depths and wherein the reaction components for treating the contaminants are mixed at at least two different depths.
